(19) United States
(12) Patent Application Publication
(10) Pub. No.: US 2016/0115920 A1
(43) Pub. Date: Apr. 28, 2016

(54) Electromagnetic Fuel Injection Valve

(71) Applicant: HITACHI AUTOMOTIVE SYSTEMS, LTD., Hitachinaka-shi, Ibaraki (JP)

(72) Inventors: Atsushi TAKAOKU, Hitachinaka (JP); Tohru ISHIKAWA, Hitachinaka (JP)

(21) Appl. No.: 14/895,371

(22) PCT Filed: Mar. 19, 2014
(86) PCT No.: PCT/JP2014/057434

§ 371 Date: Dec. 2, 2015

(30) Foreign Application Priority Data
Jun. 6, 2013 (JP) 2013-119387

(51) Int. Cl. F02M 51/06

(52) U.S. Cl. CPC F02M 51/061

(57) ABSTRACT

In regard to a junction between a metal joint and an electromagnetic fuel injection valve, a screw structure or the like is used to secure the higher sealing property and strength than those of the conventional valve, and thus, the valve becomes larger in general than the conventional valve using an O-ring structure. In addition, there is an example in which resistance welding is used in order to provide a smaller size than the screw structure as another embodiment. In this case, it is necessary to increase a dimensional accuracy of a plane on which the resistance welding is performed in order to reduce a positional deviation or squareness between the metal joint and the electromagnetic fuel injection valve. In addition, welding distortion is caused by contraction generated after the welding if the amount of weld penetration through the welding is significantly increased in order to secure the high strength, which leads an increase in the amount of the positional deviation or an increase in the squareness even when the dimensional accuracy of the plane on which welding resistance is performed is increased. In the present invention, a core as one of components that configure an electromagnetic fuel injection valve is joined with a metal joint by welding to have each melting amount of welded portion of the metal joint and the core being set such that a metal joint side has a larger melting amount than a core side. Further, a metal joint end surface, a fuel seal portion having a smaller cross-sectional area than an area of the metal joint end surface, and a core end surface having a larger area than the cross-sectional area of the fuel seal portion are provided such that the metal joint end surface and the core end surface communicate via the fuel seal portion.

### TECHNICAL FIELD

The present invention relates to an internal combustion engine, and particularly to a fuel injection valve in a cylinder injection engine for an automobile using gasoline.

### BACKGROUND ART

There has been increasing market demands on an internal combustion engine, and particularly on an electromagnetic fuel injection valve to be used in a cylinder injection system for an automobile using gasoline to allow injection at higher fuel pressure into an engine cylinder than the conventional pressure in order to satisfy regulations or requests width respect to an exhaust gas and a fuel efficiency. This is because injection speed of fuel increases, and a frictional resistance to air increases so that the fuel is further atomized and a combustion performance becomes favorable as the fuel pressure becomes high.

In regard to this, an O-ring is used in a connection portion between a fuel pipe and the electromagnetic fuel injection valve has been used in the related art, as illustrated in JP 2011-220259 A. However, the O-ring is greatly deformed in a case in which the fuel pressure is significantly higher, requested by the market, than the conventional pressure, and accordingly, it becomes difficult to secure a sealing property. Thus, a means for allowing a seal structure in the connection portion between the fuel pipe and the electromagnetic fuel injection valve to have a metal seal structure using a contact surface between a ball (fuel pipe side) made of stainless steel and a metal joint (electromagnetic fuel injection valve side) provided with a conical surface opposing the ball as illustrated in JP 2008-303810 A in order to secure the sealing property. A junction between the metal joint and the electromagnetic fuel injection valve requires not only the sealing property but also a high strength, and thus, such an electromagnetic fuel injection valve generally has a larger size than the conventional one such as the connection structure between the metal joint and the electromagnetic fuel injection valve using a screw as illustrated in JP 2008-303810 A. However, the electromagnetic fuel injection valve needs to be small in terms of an engine layout. In addition, since the electromagnetic fuel injection valve is fixed by allowing a nozzle at an opposite side to the fuel pipe side to be attached to an engine head, the electromagnetic fuel injection valve itself is bent by the fuel pipe and the engine head when a positional deviation or squareness between the fuel pipe and the electromagnetic fuel injection valve is large, and thus, there is a possibility of causing an adverse effect, that is, deterioration in performance such as an increase of variation in fuel injection quantity. Thus, a high attachment accuracy is required for the junction between the fuel pipe and the electromagnetic fuel injection valve.

### CITATION LIST Patent Literatures

PTL 1: JP 2011-220259 A

PTL 2: JP 2008-303810 A

PTL 3: JP 2006-200454 A

PTL 4: JP 2006-233866 A

### SUMMARY OF INVENTION

### Technical Problem

A screw structure or the like is used to secure the higher sealing property and strength than those of the conventional valve as illustrated in PTL 2 in regard to the junction between the metal joint and the electromagnetic fuel injection valve, and thus, the valve becomes larger in general than the conventional valve using an O-ring structure illustrated in PTL

In addition, there is an example in which resistance welding is used, as illustrated in PTL 3, in order to provide a smaller size than the screw structure as another conventional example. In this case, it is necessary to increase a dimensional accuracy of a plane on which the resistance welding is performed in order to reduce the positional deviation or the squareness between the metal joint and the electromagnetic fuel injection valve. In addition, welding distortion is caused by contraction generated after the welding if the amount of weld penetration through the welding is significantly increased in order to secure the high strength, which leads the increase in the amount of the positional deviation or the increase in the squareness even when The dimensional accuracy of the plane on which welding resistance is performed is increased.

In addition, similarly, PTL 3 also describes an embodiment in which a fuel seal portion is provided at an inner diameter side than a resistance welded portion in addition to the resistance welded portion. Even in such a case, however, it is necessary to increase the dimensional accuracy or a surface roughness accuracy for sealing. Productivity deteriorates when the dimensional accuracy or the surface roughness accuracy is increased, and a facility cost also increases. In addition, it is necessary to generate a surface pressure required for sealing in the fuel seal portion, and joining is performed while applying a high load more than necessary, which leads an increase in the facility cost.

There is also a case of allowing joining by laser welding as illustrated in PTL 4 in another embodiment. In such an example, a counterbore for positioning is provided, but fuel is sealed at a laser welding position, and thus, the area to receive fuel pressure is wide and a load becomes high.

Thus, strength required for welded portion increases. In this case, similar to the case of the resistance welding, welding distortion is caused by contraction generated after the welding if the amount of weld penetration through the welding is significantly increased in order to secure the high strength, which leads the increase in the amount of positional deviation or the increase in the squareness.

### Solution to Problem

In the present invention, a core as one of components that configure an electromagnetic fuel injection valve is joined with a metal joint by welding to have each melting amount of welded portion of the metal joint and the core being set such that a metal joint side has a larger melting amount than a core side. Further, a metal joint end surface, a fuel seal portion having a smaller cross-sectional area than an area of the metal joint end surface, and a core end surface having a larger area than the cross-sectional area of the fuel seal portion are provided such that the metal joint end surface and the core end surface communicate via the fuel seal portion.

### Advantageous Effects of Invention

According to the present invention, it is possible to decrease an area to receive a fuel pressure by sealing fuel in the fuel seal portion, and to decrease a load caused by the fuel pressure. In addition, a surface pressure required for sealing of the fuel is generated by welding distortion caused by the joining between the metal joint and the core. As a result, it is possible to reduce a laser welding strength required for the junction between the metal joint and the core, the welding distortion decreases, and it is possible to decrease the positional deviation or the squareness between the fuel pipe and the core with low cost and small space.

### BRIEF DESCRIPTION OF DRAWINGS

FIG. 1 is a cross-sectional view illustrating the entire fuel injection valve to which the present invention is implemented.

FIGS. 2(a) and 2(b) are Enlarged Views 1 of cross-sections of a metal joint 2 and a core 101.

FIG. 3 is Enlarged View 2 of cross-sections of the metal joint 2 and the core 101.

FIG. 4 is Enlarged View 3 of cross-sections of the metal joint 2 and the core 101.

FIGS. 5(a) and 5(b) are Enlarged Views 4 of cross-sections of the metal joint 2 and the core 101.

FIGS. 6(a) to 6(e) are Enlarged Views 5 of cross-sections of the metal joint 2 and the core 101.

FIGS. 7(a) to 7(f) are Enlarged Views 6 of cross-sections of the metal joint 2 and the core 101.

FIG. 8 is Enlarged View 7 of cross-sections of the metal joint 2 and the core 101.

FIG. 9 is Enlarged View 8 of cross-sections of the metal joint 2 and the core 101.

FIG. 10 is an example of stress analysis.

### DESCRIPTION OF EMBODIMENTS

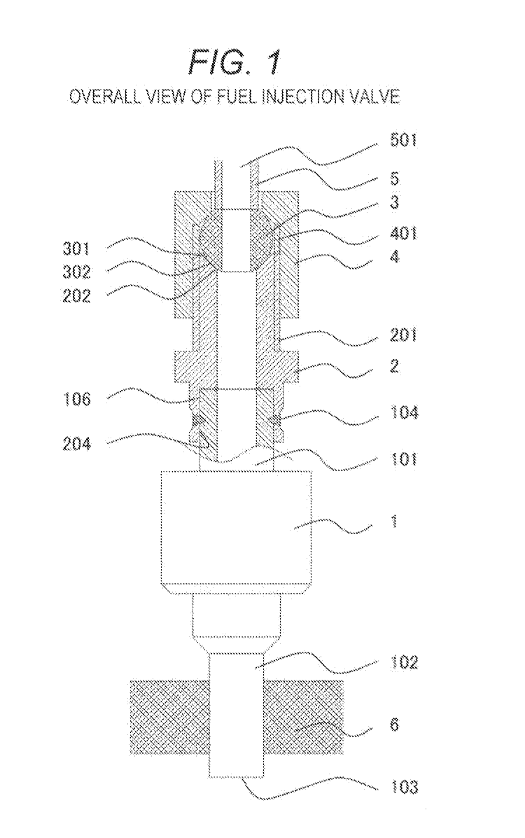

A description will be given regarding the overall configuration of embodiments with reference to FIG. 1. Although dimensions are exaggeratingly illustrated for description in the following drawings, actual scale sizes thereof are different.

Fuel is pressurized by a high-pressure pump (not illustrated) in a fuel passage 501 having a cylindrical shape of FIG. 1, and is supplied to an electromagnetic fuel injection valve 1 via a core 101 as a cylindrical member made of stainless steel. A lower end portion of the electromagnetic fuel injection valve 1 is provided with a nozzle 102 having a cylindrical shape and made of stainless steel, and an outer circumference thereof is restricted by an engine head 6. An injection hole 103 is provided in a lower end of the nozzle 102, and the supplied fuel is injected into an engine cylinder (not illustrated) by the amount and at timing which are controlled by the electromagnetic fuel injection valve 1.

A pipe 5 is a cylindrical member made of stainless steel which is provided with the fuel passage 501. A lower end of the pipe 5 is joined with a ball 3, which is made of stainless steel and provided with a cylindrical fuel passage at an inner diameter side, by welding.

The ball 3 has a spherical surface 301 at a lower end surface being in contact with a tapered surface 202 having a conical shape at 90 degrees to an upper end portion of a metal joint 2 made of stainless steel, thereby forming an annular metal seal portion 302 for sealing of the fuel.

A cap nut 4 is configured to tighten the ball 3 on the metal joint 2 using a screw portion 401 and a screw portion 201 of the metal joint 2, and a surface pressure required for the fuel sealing is applied to the metal seal portion 302 by this tightening force. Incidentally, the fuel, passage having a diameter of 5 mm communicating from the fuel passage 501 is provided in the metal joint 2 and the core 101.

A radially inner cylindrical portion 204, which has a slightly smaller diameter than an outer diameter of about 10 mm of an outer circumferential portion 106 of the core 101, is provided at a lower end of the metal joint 2, and the radially inner cylindrical portion 204 and the outer circumferential portion 106 are press-fitted.

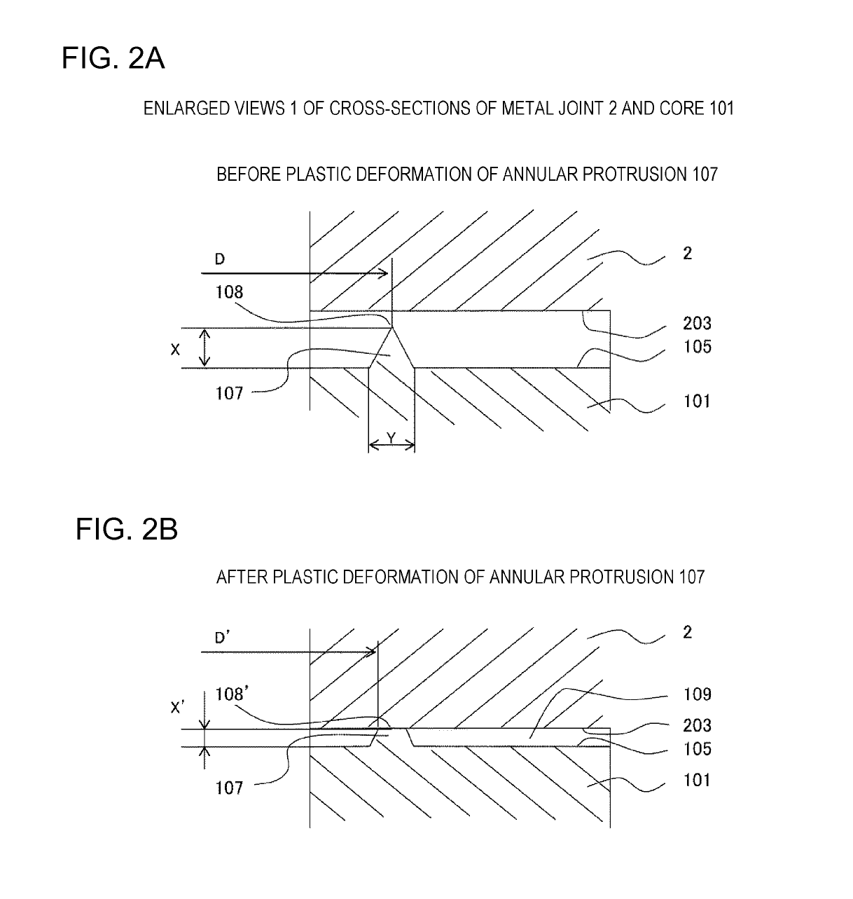

Here, a first embodiment will be described with reference to FIGS. 2(a) to 4.

In the first embodiment, an annular protrusion 107, which has a triangle cross-sectional shape, a height X=1 mm, a width Y=1 mm, and a diameter D=6 mm, is provided on a core end surface 105 as illustrated in FIG. 2(a). The core 101 is made of a material having a lower yield. stress than a yield stress of the metal joint 2.

The annular protrusion 107 is provided on an opposing surface of a lower end surface 203 of the metal joint 2, a protruding tip 108 is in contact with the end surface 203 at the time of press-fitting the core 101 to the metal joint 2. The protruding tip 108 is plastically deformed by further applying the load as illustrated in FIG. 2(b), and the press-fitting is performed until a height X thereof becomes about 0.5 mm. Presence or absence of the plastic deformation can be understood using a press-fit load or a movement amount of the core 101, but also can be confirmed by cutting a cross-section and observing a state of a metal structure of the annular protrusion 107 using a metallurgical microscope or the like. Accordingly, the annular protrusion 107 is deformed along a shape of the end surface 203 even when surface roughness or flatness of the end surface 203 is large as long as unevenness thereof is equal to or smaller than 0.5 mm, and is in contact with the end surface 203 at the entire circumference. In addition, a clearance 109 having a width of about 0.5 mm is provided between the core end surface 105 and the metal joint end surface 203 other than the annular protrusion 107.

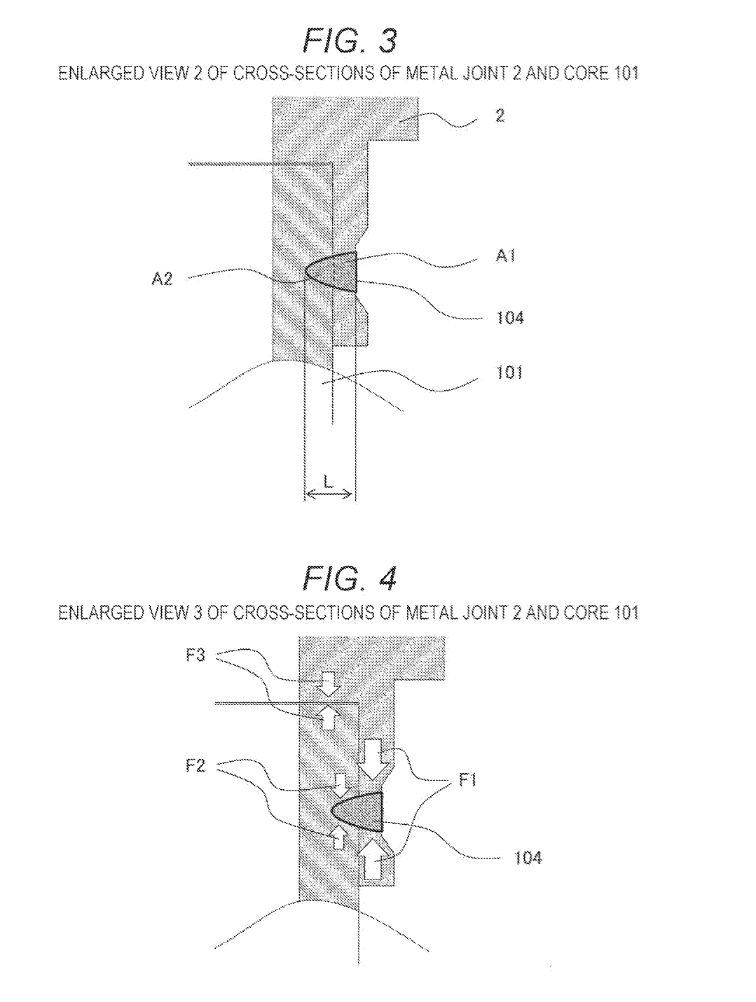

Next, the metal joint 2 and the core 101 are joined by laser welding at an outer circumference side of the metal joint 2 having an outer diameter of about 12 mm, and at a position separated from the metal joint end surface by about 4 mm in the welded portion 104 after the press-fitting of the core 101 as illustrated in FIG. 3. When a weld depth L is about 1.5 mm, the welded portion reaches a position of about a diameter of 9 mm at an inner diameter side from the outer circumferential portion 106 of the core 101. At this time, welding conditions including the weld depth L is determined. such that the welded portion 104 of the metal joint 2 and the core 101 allows the following relationship:

(Cross-sectional Area A1 of Metal Joint Side)>(Cross-sectional Area A2 of Core Side).

A description will be given regarding the load to be generated by configuring the welded portion 104 in such a manner with reference to FIG. 4. In general, it has been known that a welded portion contracts when a material is cooled and coagulated after being melt by laser as welding distortion. At this time, the welding distortion increases and the load to be generated by the welding distortion also increases as the melting amount of the material increases.

Here, the melting amount and the coagulated amount of the material are respectively obtained as follows:

(Melting Amount (Volume) of Metal Joint Side)>(Cross-sectional Area A1 of Metal Joint Side)×(Length C1 of Circumference Drawn by Centroid of A1)

(Melting Amount (Volume) of Core Side)=(Cross-sectional Area A2 of Core Side)×(Length C2 of Circumference Drawn by Centroid of A2)

(wherein, C1 and C2 are not illustrated). Each cross-sectional area A1 or A2 ) can be easily obtained by cutting a cross-section of the welded portion 104 and observing the cross-section using a microscope. The metal joint and the welded portion of the core are continuous, a difference in diameter between C1 and C2 is small because of a small weld depth, and thus, it is possible to approximate C1 to C2. Then, each melting amount has a proportional relation with each cross-sectional area A1 or A2. From the above, the load to be generated by the welding distortion in the first embodiment is as follows:

(Load F1 of Metal Joint Side)>(Load F2 of Core Side).

An this time, a load F3 caused by the welding distortion is applied in a direction in which the metal joint end surface 203 and the annular protrusion 107 of the core are compressed.

An example in which stress analysis is implemented using a finite element method with the configuration according to the first embodiment is illustrated in FIG. 10. A condition of the stress analysis is set to a case in which the welding distortion is applied in a state in which the metal joint end surface 203 is in contact with the core end surface 105, instead of the annular protrusion 107 in order for the description, at the entire surface. In a graph of FIG. 10, a horizontal axis represents a diameter of the metal joint end surface 203 or the core end surface 105, a vertical axis represents stress in an axial direction (vertical direction of the paper) generated on a contact surface between the metal joint end surface 203 and the core end surface 105, and the generated stress is displayed such that a + side is compression, and a − side is tension. According to the graph, it is understood that a compressive stress is applied onto the contact surface between the core end surface 105 and the metal joint end surface 203 due to the welding distortion of the welded portion 109 except for a part of the outermost diameter. In addition, the load to be applied to the entire surface of the contact surface between the metal joint end surface 203 and the core end surface 105 is applied in a compression direction.

When the load F3 is generated, the surface pressure required for the fuel sealing is applied to the annular contact surface between the annular protrusion 107 and the metal joint end surface 203.

With respect to the load generated by the fuel pressure, strength required for the welded portion 104 is a load F4 to be applied, by the fuel pressure, to the area (πD′2/4) of a diameter D′ portion of an annular seal surface 108′ formed by the plastic deformation of the protruding tip 108, and is represented by the following expression:

(Load F4 Caused by Fuel Pressure)=(πD′2/4)×(Fuel Pressure).

Here, D′ is about 5.5 mm in the first embodiment. In addition, in the case of sealing the fuel by the welded portion 104 (without the annular protruding portion 107), a diameter of the seal portion is about 10 mm, which is the outer diameter of the core, the area to receive the fuel pressure is smaller by about 70%. Thus, it is possible to reduce the load to be applied to the welded portion by about 70% by providing the protruding portion 107.

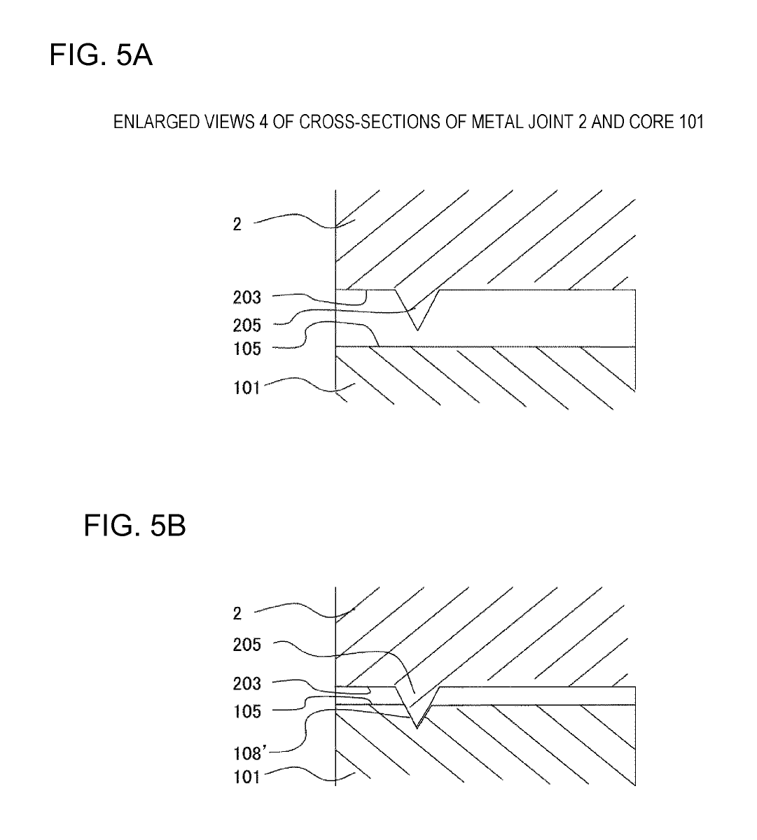

Here, a second embodiment will be described with reference to FIGS. 5(a) and 5(b).

As illustrated in FIG. 5(a), an annular protrusion 205 is provided in the metal joint end surface 203. In this case, the core end surface 105 is deformed by the press-fitting of the core 101, and the annular protrusion 205 is gouged into the core 101 as illustrated in FIG. 5(b), and the annular seal surface 108′ is formed in the core end surface 105.

The other configurations and effects are the same as those of the first embodiment.

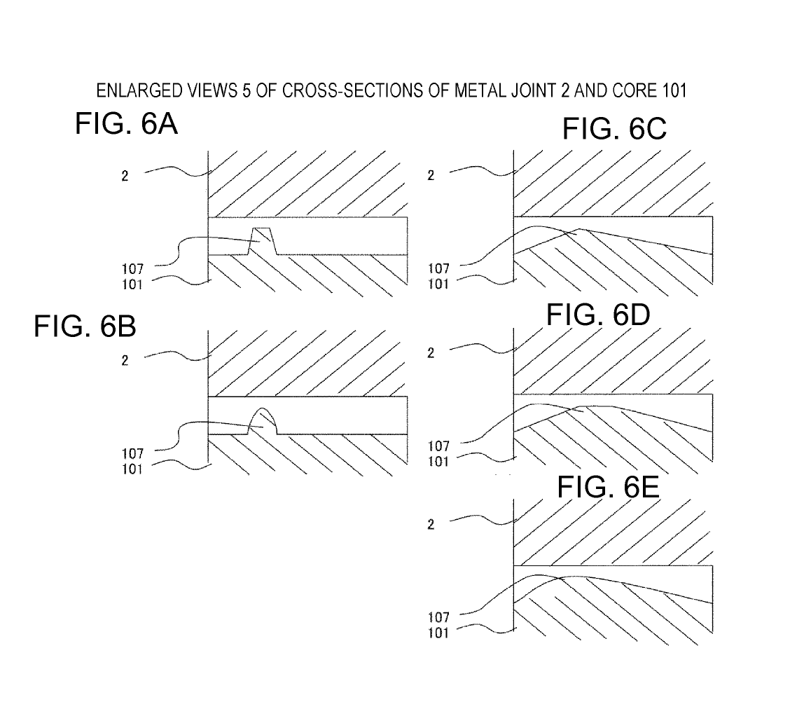

Here, a third embodiment will be described with reference to FIGS. 6(a) to 6(e).

A shape of the annular protrusion 107 may have a shape having a trapezoidal. cross-sectional shape as illustrated, in FIG. 6(a), and further, similarly, may be a rectangular shape although not illustrated. It is possible to obtain the same effects as those of The first embodiment even when the annular protrusion 107 has a curved surface shape as illustrated in FIG. 6(b). Although not illustrated, the annular protrusion 107 may be provided in plural on the core end surface 105. The annular protruding portion 107 may be formed to be tapered, to be tapered and flat, or to be curved on the entire surface of the core end surface 105 as illustrated in FIGS. 6(c) to 6(e), respectively.

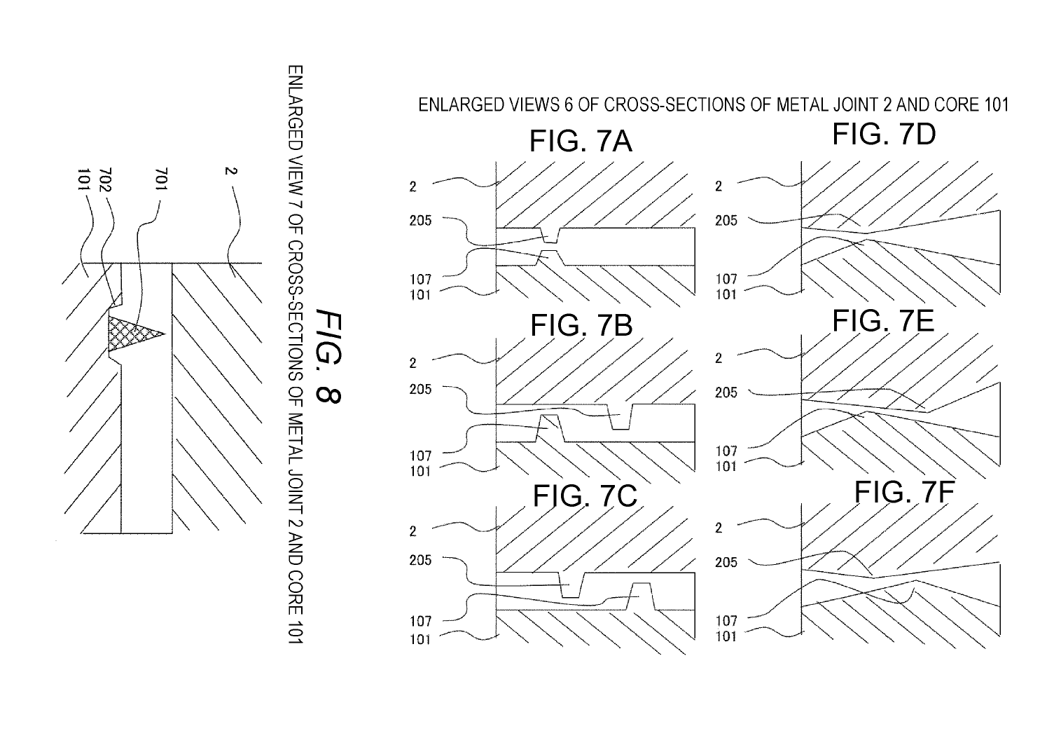

Here, a fourth embodiment will be described with reference to FIGS. 7(a) to 7(f).

As illustrated in FIGS. 7(a) to 7(c), the annular protrusion 205 is provided on the metal joint end surface 203 and the annular protrusion 107 is provided on the core end surface 105. In addition, as illustrated in FIGS. 7(d) to 7(f), the annular protrusion 205 and the annular protrusion 107 may be provided on the entire surface of the metal joint end surface 203 and the entire surface of the core end surface 105, respectively. Although not illustrated, the annular protrusions 205 and 107 may have any shape illustrated in the above-described embodiments.

Here, a fifth embodiment will be described.

Although C1 approximated to C2 in the first embodiment, a relation of the melting amount (volume) before the approximation is as follows.

(Melting Amount (Volume) of Metal Joint Side)=(Cross-sectional area A1 of Metal Joint Side)×(Length C1 of Circumference Drawn by Centroid of A1)

(Melting Amount (Volume) of Core Side)=(Cross-sectional Area A2 of Core Side)×(Length C2 of Circumference Drawn by Centroid of A2)

Since the welding distortion also increase as the melting amount of the welded portion increases, it may be configured using the following relation obtained by comparing each melting amount of the welded portion described above.

(Melting Amount (Volume) of Metal Joint Side)>(Melting Amount (Volume) of Core Side)

Incidentally, the annular protrusion 107 or 205 may be formed using combination of the respective configurations in the above-described embodiments. In addition, although the core 101 is made using a material having a lower yield stress than a yield stress of the metal joint 2, the same effects as those of the first embodiment can be obtained in the fifth embodiment regardless of the magnitude relation of the yield stress. In other words, the fifth embodiment has features in which the metal joint end surface 203, the fuel seal portion having a smaller cross-sectional area than the area of the metal joint end surface 203 for locally enhancing the surface pressure the annular protrusion 107 or 205 and the annular seal surface 108 formed by the annular protrusions 107 and 205 in the fifth embodiment), and the core end surface 105 having a larger area than the cross-sectional area of the fuel seal portion are provided, and the metal joint end surface 203 and the core end surface 105 are communicated via the annular seal surface 108′, and thus, it is possible to obtain the same effects even in a case in which a place to be plastically deformed is the annular protrusion, the metal joint end surface, the core end surface, or both the metal joint end surface and the core end surface.

In addition, although the above-described embodiments allow the unevenness in the annular seal surface 108′ using the plastic deformation in order to improve she productivity, the plastic deformation is not necessarily performed when the unevenness is originally small, the welded portion 101 and the fuel passage 501 are not communicated, and it is possible to obtain the surface pressure required for the fuel sealing at the entire circumference. In addition, although the seal surface has the annular shape in the above-described embodiments, the seal surface may be formed not in a circle but in a polygon or an ellipse such that the welded portion 104 and the fuel passage 501 are not communicated.

Here, a sixth embodiment will be described with reference to FIG. 3.

The annular protrusion 107 may be configured as an annular protruding member 701 using a different member. Even in this case, similar to the case of the above-described embodiments, the protrusion may have any shape of the above-described embodiments such as FIGS. 6(a) to 6(e). In addition, it is configured such that a dent-like groove 702 is provided on the core end surface 105 so as to be fit to the annular protruding member 701 in order to improve an assembling property by positioning.

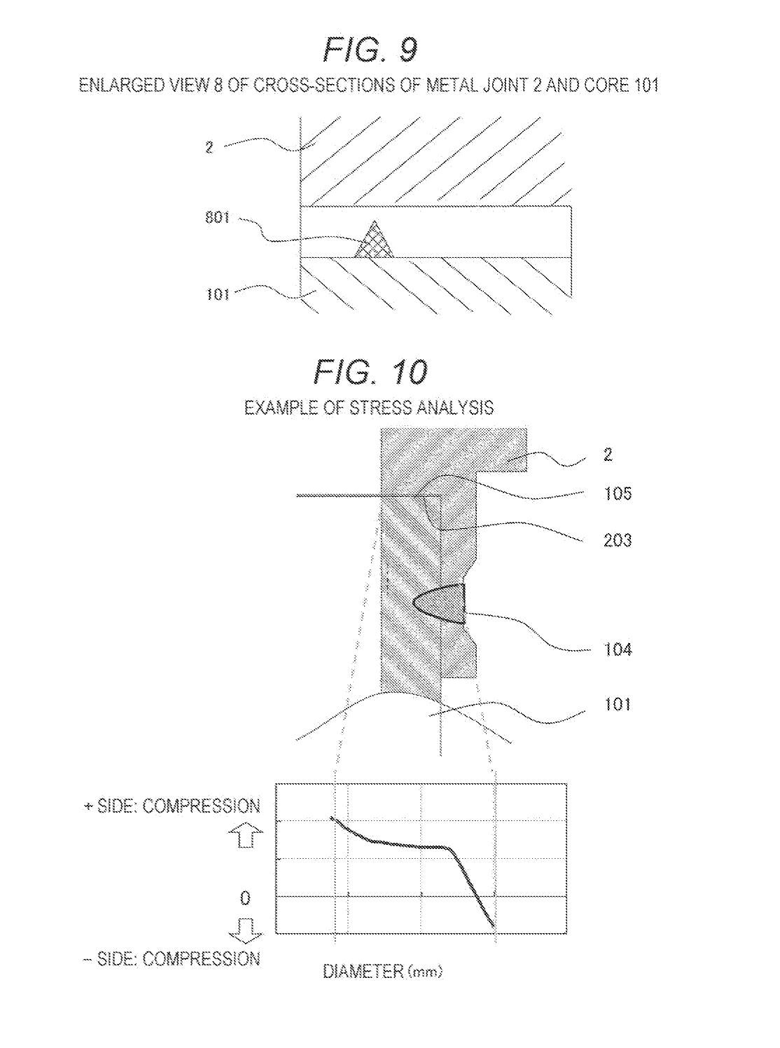

Here, a seventh embodiment will be described with reference to FIG. 9.

As illustrated in an annular protrusion 801 of FIG. 9, the above-described annular protrusion 107 may be formed using surface treatment. The surface treatment such as hard chrome plating or nickel plating may be performed after masking the core end surface 105 other than the protrusion 801 is masked. An annular protrusion is provided by the surface treatment in the same manner also in the metal joint end surface 203. Even in this case, the protrusion may have any shape of the above-described embodiments similar to the case of the sixth embodiment.

According to the above configurations, it is possible to suppress the positional deviation or a deviation in the squareness caused by the joining of the metal joint and the core with toe small space and the low cost.

### REFERENCE SIGNS LIST

1 electromagnetic fuel injection valve
101 core
102 nozzle
103 injection hole
104 welded portion
105 core end surface
106 core outer circumferential portion
107 annular protrusion
108 protruding tip
108′ annular seal surface
109 clearance
2 metal joint
201 screw portion
202 tapered surface
203 metal joint end surface
204 radially inner cylindrical portion
205 annular protrusion
3 ball
301 spherical surface
302 metal seal portion
4 cap nut
401 screw portion
5 fuel pipe
501 fuel passage
6 engine head
701 annular protruding member
702 groove on dent
801 the annular protrusion

1. An injection valve comprising:
a core having a cylindrical shape;
a metal joint to be press-fitted to an outer diameter portion of the core,
the metal joint and the core being joined using laser welding to communicate from a metal joint outer circumferential portion to an inner diameter side than a core outer circumferential portion;
a metal joint end surface;
a fuel seal portion having a smaller cross-sectional area than an area of the metal joint end surface; and
a core end surface having a larger area than the cross-sectional area of the fuel seal portion,
the metal joint end surface and the core end surface communicating via the fuel seal portion.

2. The injection valve according to claim 1, wherein
cross-sections of a welded portion of the metal joint and the core are set such that a cross-sectional area A1 of a metal joint side is larger than a cross-sectional area A2 of a core side.

3. The injection valve according to claim 1, wherein
the fuel seal portion is configured as an annular protrusion.

4. The injection valve according to claim 3, wherein
a cross-section of the annular protrusion is configured to have a triangle shape, a trapezoidal shape, a rectangular shape, or a curved surface.

5. The injection valve according to claim 3, wherein
the annular protrusion is provided on the metal joint end surface or the core end surface.

6. The injection valve according to claim 3, wherein
the annular protrusion is provided on both the metal joint end surface and the core end surface.

7. The injection valve according to claim 3, wherein
a plurality (equal to or larger than two) of the annular protrusions are provided.

8. The injection valve according to claim 1, wherein
each volume of a welded portion of the metal joint and the core is set such that a melting amount (volume) of a metal joint side is larger than a melting amount (volume) of a core side.

9. The injection valve according to claim 3, wherein
the annular protruding portion is provided as a different member from the core or the metal joint.

10. The injection valve according to claim 2, wherein
the annular protruding portion is formed on the metal joint end surface or the core end surface using surface treatment.

11. The injection valve according to claim 3, wherein
the annular protrusion is provided on an inner circumference side of the metal joint end surface or the core end surface.
